(19) United States
(12) Patent Application Publication
(10) Pub. No.: US 2025/0200653 A1
(43) Pub. Date: Jun. 19, 2025

(54) MACHINE LEARNING TECHNIQUES TO EVALUATE AND RECOMMEND ALTERNATIVE DATA SOURCES

(71) Applicant: Capital One Services, LLC, McLean, VA (US)

(72) Inventors: Srikanth BONGU, Plano, TX (US); Virginia WORDSWORTH, Washington, DC (US); Srinivas PADMALA, Schaumburg, IL (US); Creighton COOK, Richmond, VA (US)

(21) Appl. No.: 18/541,880

(22) Filed: Dec. 15, 2023

(51) Int. Cl. G06Q 40/03

(52) U.S. Cl. CPC G06Q 40/03

(57) ABSTRACT

In some implementations, a decisioning system may use a machine learning model to generate a recommended set of alternative data sources for providing information related to behavioral attributes of a user of a client device. The decisioning system may present, to the client device, an interface that indicates that the recommended set of alternative data sources. The decisioning system may receive, from the client device, a selection of one or more alternative data sources for providing information related to the behavioral attributes of the user. The decisioning system may obtain information related to the behavioral attributes of the user from the selected alternative data sources and may generate a decision associated with the application based on the information obtained from the one or more alternative data sources.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, information retrieval, and/or user interface configuration, among many other examples.

### SUMMARY

Some implementations described herein relate to a system for evaluating alternative data sources. The system may include one or more memories and one or more processors communicatively coupled to the one or more memories. The one or more processors may be configured to present an interface associated with an application to a first client device associated with a first user, wherein the interface indicates a first set of alternative data sources available for providing information related to behavioral attributes of the first user. The one or more processors may be configured to receive, from the first client device via the interface, a request indicating one or more alternative data sources that are selected, from the first set of alternative data sources, for providing information related to the behavioral attributes of the first user. The one or more processors may be configured to obtain the information related to the behavioral attributes of the first user from the one or more alternative data sources that are selected via the interface. The one or more processors may be configured to generate a decision associated with the application for the first user based on the information obtained from the one or more alternative data sources. The one or more processors may be configured to evaluate, using a machine learning model, an effectiveness of the one or more alternative data sources used to generate the decision associated with the application for the first user. The one or more processors may be configured to present the interface associated with the application to a second client device associated with a second user, wherein the interface presented to the second client device indicates a second set of alternative data sources for providing information related to behavioral attributes of the second user, and the second set of alternative data sources is output by the machine learning model based on the effectiveness of the one or more alternative data sources used to generate the decision associated with the application for the first user.

Some implementations described herein relate to a method for recommending alternative data sources. The method may include receiving, by a decisioning system, a first request to access an application from a client device associated with a user. The method may include using, by the decisioning system, a machine learning model to generate a recommended set of alternative data sources for providing information related to behavioral attributes of the user, wherein the machine learning model generates the recommended set of alternative data sources based on a set of observations related to an effectiveness of one or more combinations of alternative data sources for generating application decisions for users sharing one or more profile attributes with the user of the client device. The method may include presenting, by the decisioning system, an interface associated with the application to the client device associated with the user, wherein the interface indicates that the recommended set of alternative data sources are available for providing information related to the behavioral attributes of the user. The method may include receiving, by the decisioning system and from the client device, a second request indicating one or more alternative data sources that are selected, from the recommended set of alternative data sources, for providing information related to the behavioral attributes of the user. The method may include obtaining, by the decisioning system, the information related to the behavioral attributes of the user from the one or more alternative data sources that are selected by the user. The method may include generating, by the decisioning system, a decision associated with the application for the user based on the information obtained from the one or more alternative data sources.

Some implementations described herein relate to a non-transitory computer-readable medium that stores a set of instructions. The set of instructions, when executed by one or more processors of a system, may cause the system to receive a first request to access an application from a client device associated with a user. The set of instructions, when executed by one or more processors of the system, may cause the system to use a machine learning model to generate a recommended set of alternative data sources for providing information related to behavioral attributes of the user, wherein the machine learning model generates the recommended set of alternative data sources based on a set of observations related to an effectiveness of one or more combinations of alternative data sources for generating application decisions for users sharing one or more profile attributes with the user of the client device. The set of instructions, when executed by one or more processors of the system, may cause the system to present an interface associated with the application to the client device associated with the user, wherein the interface indicates that the recommended set of alternative data sources are available for providing information related to the behavioral attributes of the user. The set of instructions, when executed by one or more processors of the system, may cause the system to receive, from the client device, a second request indicating one or more alternative data sources that are selected, from the recommended set of alternative data sources, for providing information related to the behavioral attributes of the user. The set of instructions, when executed by one or more processors of the system, may cause the system to obtain the information related to the behavioral attributes of the user from the one or more alternative data sources that are selected by the user. The set of instructions, when executed by one or more processors of the system, may cause the system to generate a decision associated with the application for the user based on the information obtained from the one or more alternative data sources. The set of instructions, when executed by one or more processors of the system, may cause the system to evaluate an effectiveness of the one or more alternative data sources used to generate the decision associated with the application. The set of instructions, when executed by one or more processors of the system, may cause the system to update the machine learning model based on the effectiveness of the one or more alternative data sources used to generate the decision associated with the application.

### BRIEF DESCRIPTION OF THE DRAWINGS

FIGS. 1A-1B are diagrams of an example implementation associated with machine learning techniques to evaluate and recommend alternative data sources, in accordance with some embodiments of the present disclosure.

FIG. 2 is a diagram illustrating an example of training and using a machine learning model in connection with evaluating and recommending alternative data sources, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with machine learning techniques to evaluate and recommend alternative data sources, in accordance with some embodiments of the present disclosure.

FIG. 5 is a flowchart of an example process associated with machine learning techniques to evaluate and recommend alternative data sources, in accordance with some embodiments of the present disclosure.

### DETAILED DESCRIPTION

The following detailed description of example implementations refers to the accompanying drawings. The same reference numbers in different drawings may identify the same or similar elements.

When an applicant submits a credit application (e.g., for a credit product, such as a loan, a credit card, a mortgage, or the like) or an application to request pre-qualification or pre-approval for a credit product, a lender or creditor (e.g., a bank, a credit union, a mortgage company, a vehicle financing company, and/or a credit card company) typically evaluates a creditworthiness of the applicant to determine whether to extend credit to the applicant and/or to determine credit terms (e.g., an interest rate, a loan amount, and/or a credit limit) that the lender or creditor is willing to offer. In particular, creditworthiness generally refers to a measure (e.g., a probability of default) that lenders or creditors use to determine how well a credit applicant handles credit and debt obligations, which is typically determined based on an overall credit report, a credit score, a repayment history, and/or other factors that relate to how the applicant has dealt with credit in the past and/or the applicant's ability to repay debt (e.g., assets available and/or a number of liabilities, among other examples). However, one challenge that may arise when evaluating the creditworthiness of a credit applicant is that certain applicants may have an insufficient domestic credit history in a country or region where credit is sought.

For example, a potential borrower with an insufficient credit history essentially has little or no proven track record that lenders or creditors can refer to in order to assess the creditworthiness of the potential borrower (e.g., distinct from a bad credit history that may include past due payments and/or collection actions, among other examples). For example, a potential borrower may have an insufficient credit history when a credit reporting agency (or credit bureau) has no credit record for the potential borrower, or when the credit record for the potential borrower does not contain enough accounts, a sufficient payment history, or recently reported activity to calculate a reliable credit score. In some cases, young or inexperienced borrowers (e.g., students) may have insufficient credit histories because building a credit history by making consistent payments can take significant time (e.g., several years). In other cases, a potential borrower may have a credit history that is inaccessible to an institution attempting to render a credit decision for the potential borrower. For example, when a person with an extensive credit history in a home country emigrates to a different country, the credit history (including credit score) in the home country is not portable to the new country (e.g., due to variations in data protection laws and/or differences in how credit scoring and credit reports work in different countries). As a result, because a lender or creditor typically only has access to data related to a domestic credit history and lacks access to non-domestic credit reporting agencies or other data sources that may provide a non-domestic credit history, experienced immigrant borrowers that may be good credit risks (e.g., have a low probability of default and/or have demonstrated an ability to make consistent debt payments over time) may be unable to obtain a vehicle loan, a mortgage, a credit card, and/or other credit products.

Some implementations described herein relate to a decisioning system that may use one or more alternative data sources to estimate a creditworthiness for a loan or credit applicant and use one or more machine learning techniques to evaluate and recommend alternative data sources that are most likely to be effective in generating a credit decision for a loan or credit applicant with an insufficient credit history and/or a low credit score based on one or more profile attributes associated with the loan or credit applicant (e.g., depending on whether the applicant is a student, an immigrant, or associated with other suitable profile attributes). For example, in cases where a credit applicant has an insufficient credit history or a low credit score, the decisioning system may allow one or more alternative data sources (e.g., other than credit bureau data) to be used to determine income status, a bill payment history, a rental payment history, or other information that may be relevant to the creditworthiness of the applicant. However, the effectiveness or relevance of certain alternative data sources may vary depending on the type of applicant. For example, utility or telecommunication bill payments may have little or no relevant data for a student who has spent their whole life on their parents' accounts. In another example, an immigrant may have no history of making rent payments on time. Accordingly, the decisioning system may support techniques to allow a credit applicant to select one or more alternative data sources to be relied upon when there is insufficient credit bureau data or the credit bureau indicates a low credit score. The decisioning system may then use machine learning techniques to evaluate the effectiveness of the alternative data source(s) used to render the credit decision. In this way, when subsequent users access the credit application, the available data sources may be filtered or customized based on the available data sources that are most likely to be effective in informing the credit decision. In this way, by recommending alternative data sources that are most likely to provide information relevant to the credit decision, the decisioning system may conserve resources that would otherwise have been wasted communicating with alternative data sources providing data that is likely to be ineffective in informing the credit decision and/or processing data obtained from such alternative data sources.

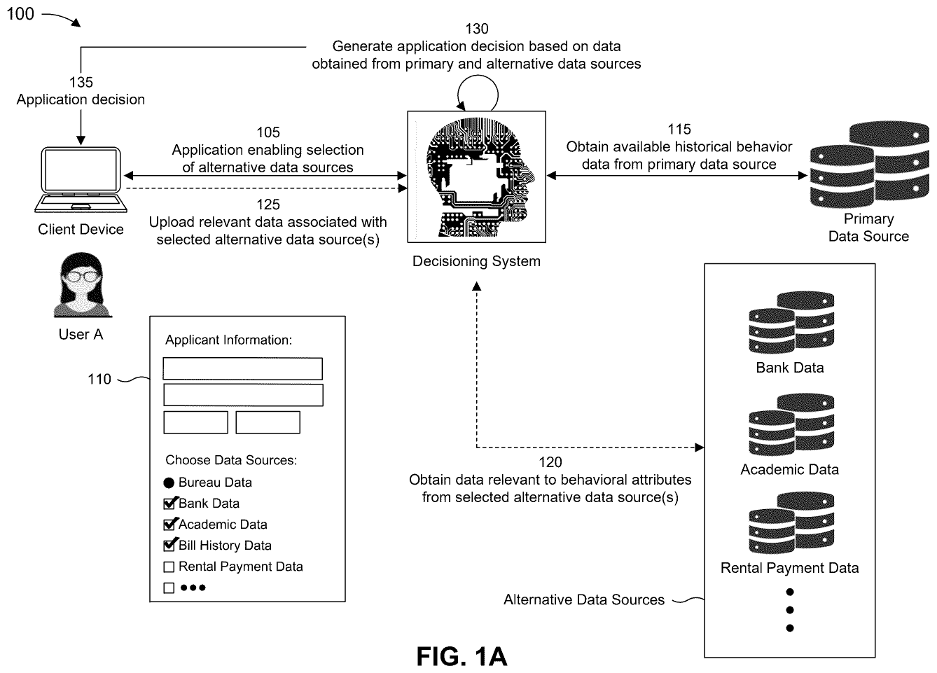

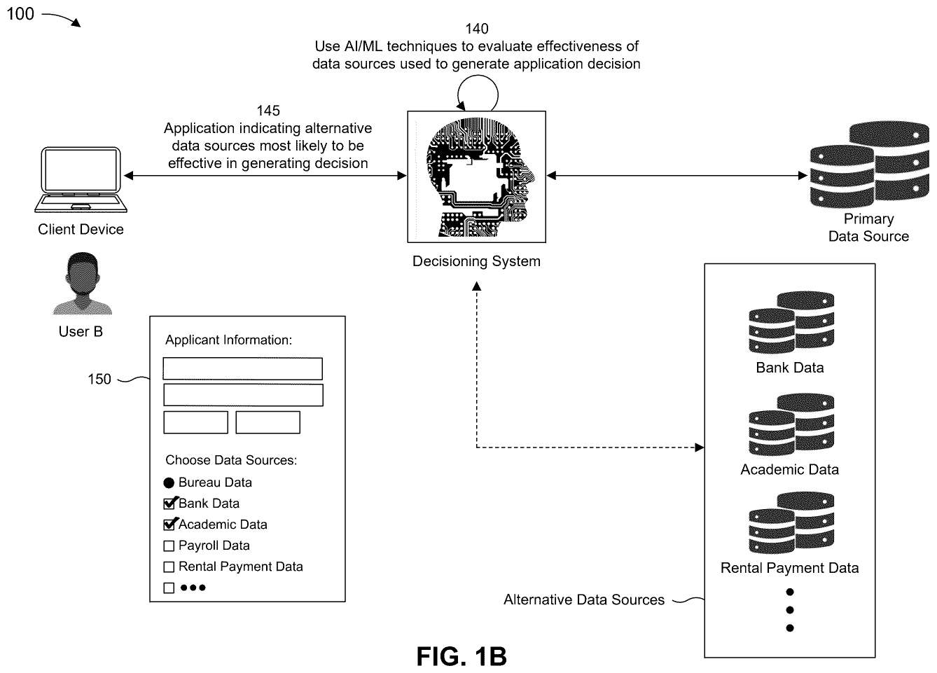

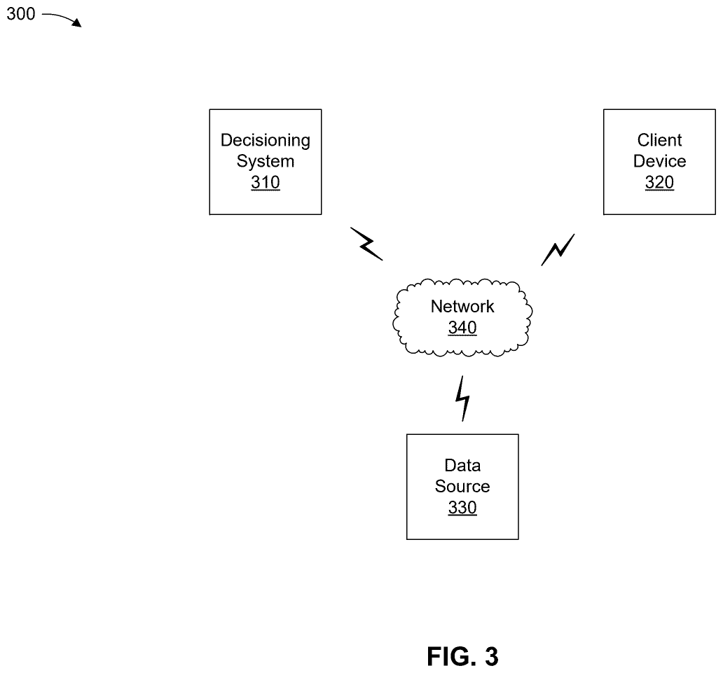

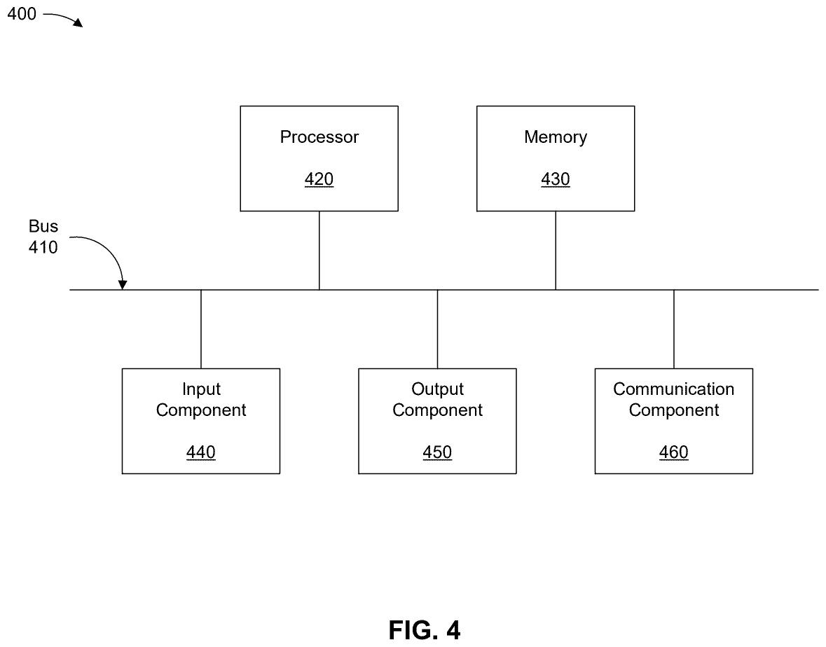

FIGS. 1A-1B are diagrams of an example 100 associated with machine learning techniques to evaluate and recommend alternative data sources. As shown in FIGS. 1A-1B, example 100 includes a decisioning system, one or more client devices, and one or more data sources. The decisioning system, the one or more client devices, and the one or more data sources are described in more detail in connection with FIG. 3 and FIG. 4.

As shown in FIG. 1A, and by reference number 105, the decisioning system may present, to a first client device associated with a first user (e.g., shown as “User A”), an interface that allows the first user to submit an application for a credit product. For example, in some implementations, the first client device may access the decisioning system via a website, a mobile application, or another suitable channel that allows the first user to submit an application for a credit product, such as a credit card, a mortgage, a personal loan, a vehicle loan, or the like, to submit an application for pre-qualification and/or pre-approval for a credit product, and/or to submit an application to increase an amount of available credit or change existing credit terms, among other examples. In some implementations, as shown by reference number 110, the interface may include one or more fields or user interface elements to allow the first user to enter personal information (e.g., a name, birth date, and/or social security number). In addition, the interface may include one or more fields or other user interface elements for the first user to indicate contact information (e.g., a mailing address, a phone number, and/or an email address) and financial information (e.g., income, residential status, employment status, and/or an approximate amount that the first user spends on recurring debt payments and/or credit cards).

In some implementations, the interface associated with the credit application may enable the first user to indicate one or more identifiers that enable or authorize the decisioning system to obtain domestic historical data associated with the applicant (e.g., a social security number in the United States, an electoral number in the United Kingdom, or a similar identifier that uniquely identifies a person for cases of credit access and monitoring). For example, as shown by reference number 110, the interface may indicate data sources that the decisioning system is to consider when generating a decision on the credit application of the first user, where the data sources that are considered may include a default primary data source (e.g., bureau data associated with one or more credit reporting agencies that store information related to the creditworthiness of various consumers, such as credit scores, repayment histories, non-payment or default histories, foreclosures, collection notices, or the like). In some implementations, the interface may be configured such that the primary data source (e.g., the bureau data) is always considered by the decisioning system. Alternatively, the interface may configure the primary data source as an option data source that the first user may select or deselect (e.g., the first user may deselect the primary data source in cases where the first user is a student, an immigrant, or otherwise has an insufficient credit history and/or in cases where the first user has a low credit score and desires to rely upon alternative data sources to prove that the first user is creditworthy).

In addition, as further shown by reference number 110, the interface associated with the credit application may indicate one or more alternative data sources that the first user can select to provide data that may be relevant to the creditworthiness of the first user. For example, as described herein, the alternative data sources may generally provide financial information that is not typically reported to the credit bureaus or agencies associated with the primary data source that the decisioning system uses to make decisions about whether to extend credit or approve a loan. For example, the alternative data sources may include information such as bank account assets, academic data, recurring bill payments (e.g., for utilities, telecommunication services, or the like), childcare payments, rental payment histories, income data, alternative loan types, and/or spending pattern data, among other examples. Accordingly, the alternative data sources may generally provide additional information related to the creditworthiness of the credit applicant beyond the credit score and/or credit score information available from the primary data source, which can increase loan approval rates for certain credit applicants because credit reports generally fail to provide a comprehensive snapshot of a consumer's creditworthiness. For example, the decisioning system may be unlikely to approve the application of the first user based solely on a low credit score that is pulled from the primary data source. However, proof of income sources and a history of on-time rental payments may indicate that the first user has a high repayment likelihood, which may change the credit decision in the applicant's favor. Additionally, or alternatively, the alternative data sources may be useful for “credit invisibles,” which refers to people lacking a credit report or credit score, people with “unscorable” credit files (e.g., due to an insufficient credit history), and/or people with stale credit files or a lack of recent credit history. In general, unscorable and credit invisible consumers are estimated to make up almost 20% percent of the adult population in the United States, and such consumers (as well as consumers with low credit scores) may not have access to quality credit and potentially face challenges with obtaining credit, housing, or the like.

Accordingly, as described herein, the interface presented by the decisioning system may allow the first user to select one or more alternative data sources, to be considered in addition to and/or instead of the primary data source, to provide more holistic and comprehensive information related to the behavioral attributes of the first user (e.g., attributes related to the creditworthiness of the first user, which relates to a probability of the first user being able to repay financial obligations). In some implementations, the first user may interact with the interface to select one or more alternative data sources to be considered by the decisioning system, which may receive, from the first client device via the interface, a request indicating the one or more alternative data sources that the first user selected from the set of alternative data sources that are available for providing information related to the behavioral attributes of the first user (e.g., attributes related to the creditworthiness of the first user).

As further shown in FIG. 1A, and by reference number 115, the decisioning system may communicate with the primary data source in an attempt to obtain any available historical behavior data associated with the first user from the primary data source after the first user has selected the alternative data sources to be considered. Alternatively, in cases where the primary data source is an optional data source that the first user can deselect, the decisioning system may refrain from communicating with the primary data source if the first user deselected the primary data source. In some implementations, in cases where the primary data source is a default and mandatory data source, or an optional data source that is selected by the first user, the decisioning system may communicate with the primary data source to request and/or obtain historical behavior data associated with the first user from the primary data source. For example, the historical behavior data may include domestic credit history data associated with the first user (e.g., credit history data in a country where a lender or creditor operating the decisioning system issues credit). For example, the primary data source may be associated with one or more credit reporting bureaus or data collection agencies that collect, from various creditors, credit history information relating to individual borrowing and bill-paying habits (e.g., existing debts, payment histories, payment delinquencies, and/or monthly payments, among other examples), which is made available to private lenders, consumer reporting agencies, credit reference agencies, credit reporting bodies, and/or other institutions. Accordingly, in some implementations, the decisioning system may request, from the primary data source, credit history data that includes a credit report and/or a credit score associated with the first user, which is typically used to evaluate the creditworthiness of a credit applicant. For example, a credit report may include information such as total debt that an individual carries, open and closed accounts, credit limits, current account balances, past due amounts, defaults, bankruptcies, and/or debt collection actions, among other examples. Furthermore, a credit score measures creditworthiness on a numerical scale (e.g., between 300 and 850 in the United States, between 300 and 900 in Canada), and is typically based on factors such as a payment history, amounts owed, and/or a length of credit history, among other examples.

In some implementations, as described herein, the decisioning system may determine that the historical behavior data associated with the first user that is accessible through the primary data source is insufficient to process or otherwise render a decision on the application of the first user (e.g., because the first user has no credit history or a stale credit history) and/or that the historical behavior data associated with the first user indicates that the application of the first user should be rejected or associated with unfavorable terms such as a high interest rate (e.g., because the first user has a low credit score or one or more payment defaults in their credit history). For example, the primary data source may have no domestic historical data for the applicant (the first user), the domestic historical data may contain a number of accounts that fail to satisfy a threshold or accounts with an age that fails to satisfy a threshold (e.g., too few accounts or accounts that are too new to calculate a reliable credit score), or the domestic historical data may be considered stale due to a lack or an insufficient amount of recently reported activity. In such cases, the decisioning system may determine that the domestic credit data accessible through the primary data source is insufficient to approve the application of the first user. However, in some cases, the applicant may be a student with a strong academic record, a recent graduate or a person with an outstanding employment offer, an expatriate or immigrant with an extensive credit history in a home country (e.g., a non-domestic country from the perspective of a lender or creditor operating the credit decision platform), or a person with a history of obtaining credit from non-traditional credit sources that generally do not report information to a credit reporting agency that operates the primary data source (e.g., a payday or auto-title lender).

Accordingly, as further shown in FIG. 1A, and by reference number 120, the decisioning system may communicate with the alternative data source(s) selected by the first user in an attempt to obtain data relevant to the behavioral attributes of the first user from the selected alternative data source(s). For example, in cases where the alternative data sources selected by the first user include bank data, the decisioning system may communicate with one or more banking systems that the first user links to their credit application to obtain historic, current, and/or pending bank account balances. Additionally, or alternatively, as shown by reference number 125, the first user may upload one or more documents or other information associated with the selected alternative data source(s), where the uploaded document(s) or other information may include the data relevant to the behavioral attributes of the first user. For example, in cases where the alternative data sources include bank data, the first user may upload bank statements that indicate income patterns (e.g., based on regular deposits) and/or spending patterns that show how money goes in and out of the bank account(s) held by the first user. Furthermore, as shown, the alternative data sources may include academic data, such as transcripts, enrollment histories, tuition payments, room-and-board payments, or other relevant information in cases where the first user is a student at an academic institution. Other alternative data sources may include bill payment data, such as regular bill payments for utilities, phone service, or insurance to show that the first user has a history of paying bills on time, rental payment data showing on-time rental payments over an extended time period (e.g., accessible through property management companies or bank account transactions), alternative loan types such as buy-now-pay-later (BNPL) loans and paycheck advances that may not be accounted for in the traditional credit scoring or credit reporting provided by the primary data source, and/or income data shown in documents and/or bank inflows, such as paystubs, 1099s, and W2s.

In general, the decisioning system may obtain the data from the selected alternative data sources by electronically communicating with payroll providers, banks, academic institutions, utility companies, telecommunication companies, property management companies, or the like (e.g., using an application program interface (API) or a token-based or credential-based delegation framework, such as Open Authorization or “OAuth”). In some implementations, in cases where the decisioning system obtains data relevant to financial behavior or a financial profile of the first user from multiple alternative data sources, the decisioning system may pull the data from the multiple alternative data sources in parallel, to decrease the time before a decision can be rendered on the credit application. Additionally, or alternatively, as described herein, the first user may manually upload the documents or other data associated with one or more of the selected alternative data source(s), which may then be subject to automated and/or manual review to extract the relevant financial behavior or financial profile attributes.

As further shown in FIG. 1A, and by reference number 130, the decisioning system may generate a decision on the application of the first user based on the data obtained from the primary data source and the data associated with the selected alternative data source(s). For example, in some implementations, the decisioning system may determine one or more credit metrics associated with the first user based on any credit score or credit report obtained from the primary data source associated with the credit bureau or reporting agencies, and further based on relevant information obtained from the alternative data sources. For example, in some implementations, the credit metrics that are derived from the alternative data sources may include information similar to what the decisioning system would normally obtain from a credit report and/or credit score obtained from the primary data source, such as whether the applicant is making payments on time, how many lenders or creditors the applicant is paying on time, a number of late payments, sums of money that the applicant regularly pays in a given time interval (e.g., per month or per year), account balances (e.g., individual and total account balances), a length of credit history (e.g., an oldest account), a number of open accounts, available credit, credit usage (e.g., a percentage of total available credit that is used), a number of credit checks, and/or a number of defaults or collections, among other examples. In this way, the alternative data sources may be used to derive a credit history associated with the applicant in cases where the domestic credit history of the applicant (e.g., the credit report and/or credit score of the applicant) is insufficient to process the credit request (e.g., because the applicant is a student, an immigrant, a person with no credit history or a stale or unscorable credit history, a credit invisible, a person with a low credit score, or other new-to-credit consumer type). Furthermore, in some implementations, the credit metrics that are determined based on the alternative data sources may include information related to an income of the applicant, assets available to the applicant, spending patterns of the applicant, or the like, all of which may be indicative of the applicant's ability to make payments on time.

Accordingly, as described herein, the decisioning system may generate a decision on the credit application of the first user based on the credit metrics that are derived from the data obtained from the primary data source (if any) and the credit metrics that are derived from the data obtained from the alternative data sources. In some implementations, the decisioning system may apply different weights to different data sources, such as a high weight being applied to the data obtained from the primary data source (if any) relative to the data obtained from the alternative data source(s), or vice versa. For example, in some implementations, the decisioning platform may apply a creditworthiness model that gives more weight to traditional credit scores, or may apply an alternative credit scoring model that applies more weight to rent payments, transactional activity, an income stream, or the like relative to traditional credit scores. In this way, the alternative data sources can be used to generate a more complete behavioral profile of the first user applying for the credit product, and may either replace or augment traditional credit scores and credit reports available through the primary data source. For example, credit scores are typically refreshed on a monthly basis and therefore tend to be lagging indicators of creditworthiness, whereby alternative data sources such as recent cash flow and account balances may provide a more accurate real-time profile of the applicant's financial status. Furthermore, credit scores and credit reports tend to be indicative of past financial behaviors related to repaying previous or current debts, but do not provide a comprehensive profile of the applicant's financial status. Accordingly, the alternative data sources may provide additional insights into the applicant's financial profile and may uncover additional risk factors that are not reflected in a credit score or credit report (e.g., data such as missed rent payments or a lack of income may indicate risk factors for an applicant with a good credit score or good credit history). In addition, when accessed electronically, the decisioning system can easily refresh the data available through the alternative data sources to monitor for changes in cash flow and gain access to more current information during the decisioning process.

Accordingly, as described herein, the decisioning system may use the credit metrics to estimate a creditworthiness of the first user, which may be mapped to a credit score in a similar manner as information contained in a credit report. For example, in some implementations, the decisioning system may apply a credit scoring algorithm that assigns respective weights to a payment history metric, a credit history metric, a credit usage metric, a total balance metric, a credit check metric, an available credit metric, and/or other suitable metrics that are derived from the data obtained from the alternative data sources. In this way, the decisioning system may remap the credit history data obtained from the alternative data sources to an approval flow that is based on a domestic credit history obtained from the primary data source. In this way, the decisioning system may render a decision on the application from the first user based on the behavioral attributes that define the applicant's financial profile based on the data obtained from the primary and alternative data sources. For example, in some implementations, the credit decision platform may generate a decision to approve the credit application (e.g., offering a loan or credit card based on the primary and/or alternative data sources proving a good credit history and/or based on the applicant having income, assets, spending patterns, payment histories, or other behaviors indicating that the applicant can reliably make payments). Alternatively, in some implementations, the decisioning system may reject the credit application (e.g., based on the alternative data sources showing a poor credit history and/or based on the applicant having income, assets, spending patterns, payment histories, or other behaviors indicating that the applicant is likely to have difficulty making payments). As further shown in FIG. 1A, and by reference number 135, the decisioning system may then provide, to the first client device, information that indicates the application decision that was generated for the first user based on the data obtained from the primary data source and the selected alternative data source(s).

As shown in FIG. 1B, and by reference number 140, the decisioning system may use one or more artificial intelligence or machine learning models to evaluate an effectiveness of the data sources that were used to generate the decision on the application of the first user. For example, in some implementations, the alternative data sources that are most helpful or effective to generate the decision on the application of the first user may vary depending on the applicant or consumer type. For example, a student with little to no credit history is unlikely to have a significant history of paying utility, phone, or other bills on time, but data available from academic reports or academic institutions may be more likely to be effective or relevant in predicting the creditworthiness of the student applicant. In another example, for an immigrant with no domestic credit history but an extensive credit history in a home country, alternative data sources such as banks, bill payment histories, and/or rental payment histories may be more relevant or effective than academic reports. Furthermore, whether alternative data sources were used or influenced the decision on the credit application may be evaluated even for users with credit scores or credit report data available from the primary data source (e.g., because the alternative data sources may indicate risk factors that are not reflected in traditional credit scores or credit report data and/or may bolster a good credit score or credit report data). Accordingly, in some implementations, the decisioning system may use the artificial intelligence or machine learning models to evaluate the data sources that were used to generate the decision on the credit application of the first user in combination with one or more attributes related to a profile of the first user (e.g., whether the first user is a credit invisible, a student, an immigrant, a new-to-credit consumer, a consumer with an extensive domestic credit history, or the like, a type of credit product that the first user is applying for, and/or whether the user is associated with a demographic profile that is more likely to have no credit history or insufficient current credit history to produce a credit score, among other examples). In this way, the decisioning system may predict and/or generate recommendations about which alternative data source combinations are most effective for future applicants associated with certain attributes or profile information. In this way, the predictions and/or recommendations about which alternative data source combinations are most effective for future applicants may be used to determine which alternative data sources are presented or recommended to future applicants applying for credit.

For example, as further shown in FIG. 1B, and by reference number 145, the decisioning system may present, to a second client device associated with a second user (e.g., shown as “User B”), an interface that allows the second user to submit an application for a credit product. In this case, when the second user provides personal, contact, and/or financial information via the interface, the decisioning system may determine one or more attributes or a profile that indicates a customer type associated with the second user (e.g., student, immigrant, person with extensive credit history, person with stale credit history, new-to-credit customer, or the like). In this way, the decisioning system may use the one or more artificial intelligence or machine learning models to determine a set of alternative data sources that are presented to the second user via the interface based on the customer type associated with the second user (e.g., indicating alternative data sources that are most likely to have data relevant to building an accurate and more comprehensive behavioral profile of the second user based on the overall financial state of the second user). For example, as shown by reference number 150 in FIG. 1B, the set of alternative data sources that are presented to the second user include bank data, academic data, payroll data, and rental payment data, and the set of alternative data sources that are presented to the second user do not include bill history data (e.g., based on the second user having a profile indicating that the second user is unlikely to have an extensive history of bill payments). Accordingly, the second user may then select the alternative data sources to be relied upon in the credit application of the second user, and the decisioning system may obtain the data related to the financial state of the second user from the primary data source and/or the alternative data sources selected by the second user in a similar manner as described above. Furthermore, when the decisioning system renders a decision on the application of the second user, the decisioning system may similarly use the artificial intelligence or machine learning algorithms to evaluate the data sources that were used, the profile of the second user, and the approval/rejection decision to refine the recommendations regarding which alternative data source combinations are most effective for different customer types. Furthermore, although the set of alternative data sources presented to the user(s) applying for credit are filtered or otherwise customized based on the profile of the user(s), the interface presented to the client device(s) may provide the user(s) applying for credit with an option to select other alternative data sources that are not included in the initial set of alternative data sources presented to the user(s).

As indicated above, FIGS. 1A-1B are provided as an example. Other examples may differ from what is described with regard to FIGS. 1A-1B.

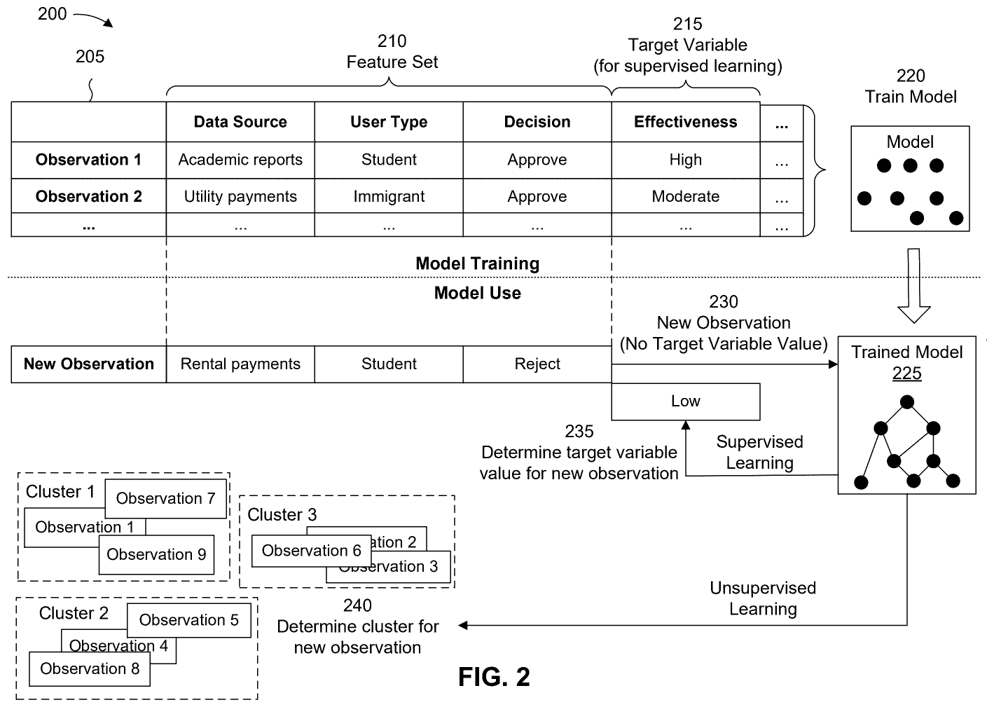

FIG. 2 is a diagram illustrating an example 200 of training and using a machine learning model in connection with evaluating and recommending alternative data sources. The machine learning model training and usage described herein may be performed using a machine learning system. The machine learning system may include or may be included in a computing device, a server, a cloud computing environment, or the like, such as the decisioning system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from one or more alternative data sources, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from one or more alternative data sources. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of data source, a second feature of user type, a third feature of decision, and so on. As shown, for a first observation, the first feature may have a value of academic reports, the second feature may have a value of student, the third feature may have a value of approve, and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is effectiveness, which has a value of high for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, in some implementations, the machine learning system may evaluate whether data obtained from a given alternative data source was effective in informing a credit decision for a given credit applicant based on a type or profile associated with the credit applicant, based on whether the credit decision was to approve or reject the credit application, and/or based on one or more terms (e.g., an interest rate) that were offered in cases where the credit decision was to approve the credit application, among other examples. After training, the machine learning system may store the machine learning model as a trained machine learning model 225 to be used to analyze new observations.

As an example, the machine learning system may obtain training data for the set of observations based on historical credit applications associated with users that selected or requested that one or more alternative data sources be considered for their credit applications in addition to and/or instead of a credit score, credit report, or other data in a primary data source.

As shown by reference number 230, the machine learning system may apply the trained machine learning model 225 to a new observation, such as by receiving a new observation and inputting the new observation to the trained machine learning model 225. As shown, the new observation may include a first feature of rental payments, a second feature of student, a third feature of reject, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of low for the target variable of effectiveness for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, excluding rental payments from the set of alternative data sources that are initially presented to users that are associated with a student profile type. The first automated action may include, for example, generating an interface in which a set of alternative data sources initially presented to a user associated with a student profile type does not include rental payments.

As another example, if the machine learning system were to predict a value of high for the target variable of effectiveness, then the machine learning system may provide a second (e.g., different) recommendation (e.g., a recommendation to include rental payments in the set of alternative data sources that are initially presented to users that are associated with a student profile type) and/or may perform or cause performance of a second (e.g., different) automated action (e.g., generating an interface in which a set of alternative data sources initially presented to a user associated with a student profile type includes rental payments).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., effective alternative data sources for users associated with certain attributes or profile types), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include alternative data sources that were used for credit applicants, attributes or profile information associated with such credit applicants, decisions that were generated on the credit applications for users associated with certain attributes or profile information, and/or how effective the alternative data sources were in influencing or informing the decisions that were generated on the credit applications for users associated with certain attributes or profile information.

In this way, the machine learning system may apply a rigorous and automated process to determine the best combination of alternative data sources to present to credit applicants associated with certain attributes or profile information. The machine learning system may enable recognition and/or identification of tens, hundreds, thousands, or millions of features and/or feature values for tens, hundreds, thousands, or millions of observations, thereby increasing accuracy and consistency and reducing delay associated with determining the best combination of alternative data sources to present to credit applicants associated with certain attributes or profile information relative to requiring computing resources to be allocated for tens, hundreds, or thousands of operators to manually determine the best combination of alternative data sources using the features or feature values. Furthermore, by predicting or recommending a combination of alternative data sources that is most likely to be effective in generating a decision on a credit application, the machine learning system may conserve resources that would have otherwise been consumed communicating with alternative data sources and/or processing data from alternative data sources that are likely to be ineffective or marginally effective in generating a decision on a credit application.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a decisioning system 310, a client device 320, a data source 330, and a network 340. Devices of environment 300 may interconnect via wired connections, wireless connections, or a combination of wired and wireless connections.

The decisioning system 310 includes one or more devices capable of receiving, generating, storing, processing, providing, and/or routing information associated with machine learning techniques to evaluate and recommend alternative data sources, as described elsewhere herein. The decisioning system 310 may include a communication device and/or a computing device. For example, the decisioning system 310 may include a server, such as an application server, a client server, a web server, a database server, a host server, a proxy server, a virtual server (e.g., executing on computing hardware), or a server in a cloud computing system. In some implementations, the decisioning system 310 includes computing hardware used in a cloud computing environment.

The client device 320 includes one or more devices capable of receiving, generating, storing, processing, and/or providing information associated with machine learning techniques to evaluate and recommend alternative data sources, as described elsewhere herein. The client device 320 may include a communication device and/or a computing device. For example, the client device 320 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The data source 330 may include one or more devices capable of receiving, generating, storing, processing, and/or providing information associated with machine learning techniques to evaluate and recommend alternative data sources, as described elsewhere herein. The data source 330 may include a communication device and/or a computing device. For example, the data source 330 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the data source 330 may include a primary data source that stores information related to credit scores or repayment histories associated with one or more credit reporting bureaus or agencies and/or one or more alternative data sources that store other information that may be relevant to personal creditworthiness, as described elsewhere herein.

The network 340 includes one or more wired and/or wireless networks. For example, the network 340 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with machine learning techniques to evaluate and recommend alternative data sources. The device 400 may correspond to the decisioning system 310, the client device 320, and/or the data source 330. In some implementations, the decisioning system 310, the client device 320, and/or the data source 330 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

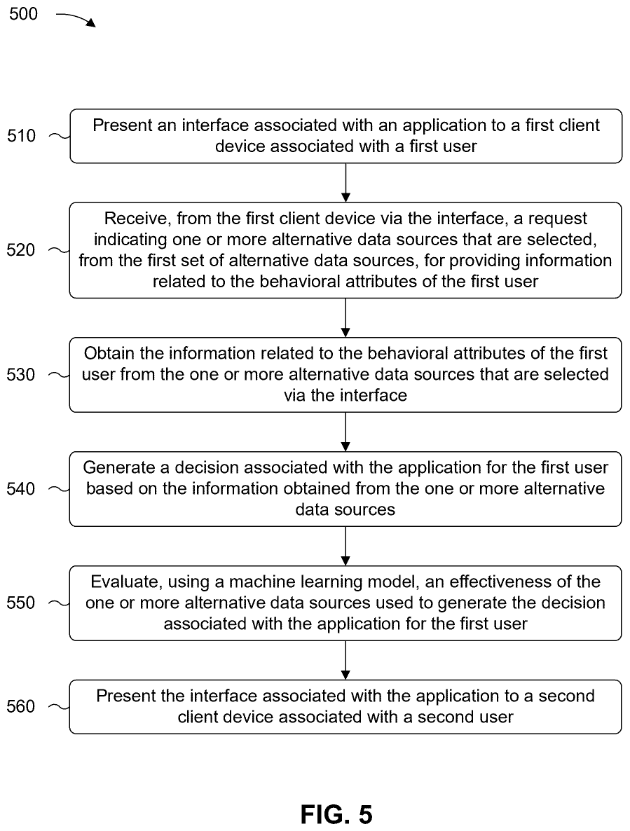

FIG. 5 is a flowchart of an example process 500 associated with machine learning techniques to evaluate and recommend alternative data sources. In some implementations, one or more process blocks of FIG. 5 may be performed by the decisioning system 310. In some implementations, one or more process blocks of FIG. 5 may be performed by another device or a group of devices separate from or including the decisioning system 310, such as the client device 320 and/or the data source 330. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include presenting an interface associated with an application to a first client device associated with a first user (block 510). For example, the decisioning system 310 (e.g., using processor 420, memory 430, input component 440, output component 450, and/or communication component 460) may present an interface associated with an application to a first client device associated with a first user, as described above in connection with reference numbers 105 and 110 of FIG. 1A. In some implementations, the interface indicates a first set of alternative data sources available for providing information related to behavioral attributes of the first user. As an example, the interface presented to the first client device may include a user interface that enables the first user of the first client device to submit an application for a credit product or an application for pre-approval or pre-qualification for a credit product, such as a vehicle loan, a credit card, a mortgage, or the like. Accordingly, in some implementations, the interface may include one or more fields that allow the first user to enter personal, contact, and financial information associated with the first user, which may enable the decisioning system to perform a credit pull by obtaining a credit score or credit report from a primary data source (e.g., associated with one or more credit bureaus or credit reporting agencies). In addition, the interface may indicate a set of alternative data sources that may include additional behavioral data to derive a more comprehensive and detailed financial profile associated with the first user. For example, in some implementations, the set of alternative data sources may include bank data, academic data, bill history data, rental payment data, payroll or income data, alternative loan data (e.g., BNPL or paycheck advance data), website behavioral data (e.g., how the user interacts with the interface, website, or mobile application provided by the decisioning system), or the like. In some implementations, the set of alternative data sources that are presented to the first user may include a default set of alternative data sources that are not customized or filtered according to a profile associated with the user. Alternatively, in some implementations, the set of alternative data sources that are presented to the first user may include a recommended combination of alternative data sources that are most likely to be effective in influencing a decision on the application submitted by the first user based on a profile associated with the user (e.g., based on alternative data sources that were determined to be historically effective in influencing decisions on applications submitted by other users having the same or a similar profile as the first user).

As further shown in FIG. 5, process 500 may include receiving, from the first client device via the interface, a request indicating one or more alternative data sources that are selected, from the first set of alternative data sources, for providing information related to the behavioral attributes of the first user (block 520). For example, the decisioning system 310 (e.g., using processor 420, memory 430, input component 440, output component 450, and/or communication component 460) may receive, from the first client device via the interface, a request indicating one or more alternative data sources that are selected, from the first set of alternative data sources, for providing information related to the behavioral attributes of the first user, as described above in connection with reference numbers 105 and 110 of FIG. 1A. As an example, the first user may select one or more (or all) of the alternative data sources that are indicated in the interface in order to request that data from the alternative data sources be considered by the decisioning system when generating a decision on the application submitted by the first user. For example, in some implementations, the selected alternative data sources may include bank data, academic data, bill history data, rental payment data, payroll or income data, alternative loan data, website behavioral data, or the like.

As further shown in FIG. 5, process 500 may include obtaining the information related to the behavioral attributes of the first user from the one or more alternative data sources that are selected via the interface (block 530). For example, the decisioning system 310 (e.g., using processor 420, memory 430, input component 440, output component 450, and/or communication component 460) may obtain the information related to the behavioral attributes of the first user from the one or more alternative data sources that are selected via the interface, as described above in connection with reference number 120 of FIG. 1A. As an example, the first user may be provided with options to provide access credentials or otherwise link accounts that the first user holds with entities providing the alternative data sources (e.g., using OAuth or an API-based interface), which may allow the decisioning system to electronically communicate with the alternative data sources and obtain the data indicating the behavioral attributes of the first user (e.g., academic reports may indicate an academic record of the first user and/or whether the first user has historically made tuition, room, board, and/or other payments on time, bank data may indicate the income or cash flow available to the first user and/or spending patterns of the first user, and/or bill payment data may indicate whether the first user has historically made bill payments on time, among other examples). Additionally, or alternatively, the first user may upload one or more documents, such as bank statements or the like, to the decisioning system to provide the data associated with the alternative data sources.

As further shown in FIG. 5, process 500 may include generating a decision associated with the application for the first user based on the information obtained from the one or more alternative data sources (block 540). For example, the decisioning system 310 (e.g., using processor 420, memory 430, input component 440, output component 450, and/or communication component 460) may generate a decision associated with the application for the first user based on the information obtained from the one or more alternative data sources, as described above in connection with reference number 130 of FIG. 1A. As an example, the decisioning system may employ a suitable algorithm to determine the creditworthiness of the first user based on the information obtained from the one or more alternative data sources, which may be evaluated alone or in combination with a credit score or credit report data obtained from a primary data source. For example, the creditworthiness may generally include a metric or measure related to how likely the first user is to be able to make payments on time, which may influence whether to approve or reject the credit application of the first user and/or one or more terms to offer to the first user in cases where the decision is to approve the application of the first user (e.g., the information obtained from the alternative data sources may influence a number of months or an interest rate for a loan to be approved for the first user).

As further shown in FIG. 5, process 500 may include evaluating, using a machine learning model, an effectiveness of the one or more alternative data sources used to generate the decision associated with the application for the first user (block 550). For example, the decisioning system 310 (e.g., using processor 420, memory 430, input component 440, output component 450, and/or communication component 460) may evaluate, using a machine learning model, an effectiveness of the one or more alternative data sources used to generate the decision associated with the application for the first user, as described above in connection with reference number 140 of FIG. 1B. As an example, the decisioning system may use machine learning techniques to evaluate the effectiveness of the alternative data sources that were used to generate the decision associated with the application for the first user, which may be based on the volume of data that was available through each alternative data source, the relevance of the data available through each alternative data source with respect to estimating the creditworthiness of the first user (e.g., how well the alternative data related to historical financial behaviors predict the ability of the first user to make future payments), the freshness or staleness of the data obtained from each alternative data source, and/or the quality or reliability of the data obtained from each alternative data source, among other examples. In addition, the decisioning system may evaluate a profile of the first user, such as whether the first user is a student, an immigrant, a credit invisible, a consumer with an unscorable credit history, a new-to-credit consumer, or associated with another suitable profile of users that tend to have no credit history or an insufficient (e.g., thin or stale) credit history. Additionally, or alternatively, the profile of the first user may indicate other suitable attributes, such as a demographic profile, an employment status, or other attributes that indicate a likelihood of the first user having a sufficient credit history available through the primary data source and/or a creditworthiness of the first user that is indicated by any credit history that is available through the primary data source.

As further shown in FIG. 5, process 500 may include presenting the interface associated with the application to a second client device associated with a second user (block 560). For example, the decisioning system 310 (e.g., using processor 420, memory 430, input component 440, output component 450, and/or communication component 460) may present the interface associated with the application to a second client device associated with a second user, as described above in connection with reference numbers 145 and 150 of FIG. 1B. In some implementations, the interface presented to the second client device indicates a second set of alternative data sources for providing information related to behavioral attributes of the second user. In some implementations, the second set of alternative data sources is output by the machine learning model based on the effectiveness of the one or more alternative data sources used to generate the decision associated with the application for the first user. As an example, the effectiveness of the alternative data sources used to generate the decision associated with the application of the first user may be used to determine or recommend a set of alternative data sources (e.g., a single alternative data source or a combination of multiple alternative data sources) that are likely to be effective data sources for other users having a similar profile as the first user. Accordingly, in some implementations, the second set of alternative data sources that are presented to the second user may include the set of alternative data sources that were determined to be effective data sources for the first user and/or historically effective for other users having a similar profile as the first user (e.g., based on the second user having the same or a similar profile as the first user).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for evaluating alternative data sources, the system comprising:
one or more memories; and
one or more processors, communicatively coupled to the one or more memories, configured to:
present an interface associated with an application to a first client device associated with a first user,
wherein the interface indicates a first set of alternative data sources available for providing information related to behavioral attributes of the first user;
receive, from the first client device via the interface, a request indicating one or more alternative data sources that are selected, from the first set of alternative data sources, for providing information related to the behavioral attributes of the first user;
obtain the information related to the behavioral attributes of the first user from the one or more alternative data sources that are selected via the interface;
generate a decision associated with the application for the first user based on the information obtained from the one or more alternative data sources;
evaluate, using a machine learning model, an effectiveness of the one or more alternative data sources used to generate the decision associated with the application for the first user; and
present the interface associated with the application to a second client device associated with a second user, wherein:
the interface presented to the second client device indicates a second set of alternative data sources for providing information related to behavioral attributes of the second user, and
the second set of alternative data sources is output by the machine learning model based on the effectiveness of the one or more alternative data sources used to generate the decision associated with the application for the first user.

2. The system of claim 1, wherein the first set of alternative data sources is output by the machine learning model based on one or more combinations of alternative data sources that were effective to generate decisions associated with the application for previous users.

3. The system of claim 1, wherein the machine learning model is trained to evaluate the effectiveness of the one or more alternative data sources used to generate the decision associated with the application based on whether the application was approved or rejected.

4. The system of claim 1, wherein the machine learning model is trained to evaluate the effectiveness of the one or more alternative data sources used to generate the decision associated with the application based on a profile associated with the first user.

5. The system of claim 1, wherein the one or more processors are further configured to:
use the output by the machine learning model to generate the second set of alternative data sources presented to the second client device based on a profile associated with the second user of the second client device.

6. The system of claim 1, wherein the one or more processors are further configured to:
communicate with a primary data source that stores historical behavior data for a population of users to request information relevant to the behavioral attributes of the first user,
wherein the interface indicates the one or more alternative data sources for providing the information related to the behavioral attributes of the first user based on the historical behavior data stored in the primary data source being insufficient to generate the decision on the application for the first user.

7. The system of claim 1, wherein the one or more processors are further configured to:
communicate with a primary data source that stores historical behavior data for a population of users to request information relevant to the behavioral attributes of the first user,
wherein the interface indicates the one or more alternative data sources for providing the information related to the behavioral attributes of the first user based on the historical behavior data stored in the primary data source indicating that the application should be rejected for the first user.

8. The system of claim 1, wherein the one or more processors, to obtain the information related to the behavioral attributes of the first user from the one or more alternative data sources, are configured to:
receive, via the interface associated with the application, information enabling communication with the one or more alternative data sources; and
communicate with the one or more alternative data sources to obtain the information related to the behavioral attributes of the first user based on the information enabling communication with the one or more alternative data sources.

9. The system of claim 1, wherein the one or more processors, to obtain the information related to the behavioral attributes of the first user from the one or more alternative data sources, are configured to:
receive, via the interface associated with the application, one or more document uploads that include the information related to the behavioral attributes of the first user.

10. A method for recommending alternative data sources, comprising:
receiving, by a decisioning system, a first request to access an application from a client device associated with a user;
using, by the decisioning system, a machine learning model to generate a recommended set of alternative data sources for providing information related to behavioral attributes of the user,
wherein the machine learning model generates the recommended set of alternative data sources based on a set of observations related to an effectiveness of one or more combinations of alternative data sources for generating application decisions for users sharing one or more profile attributes with the user of the client device;
presenting, by the decisioning system, an interface associated with the application to the client device associated with the user,
wherein the interface indicates that the recommended set of alternative data sources are available for providing information related to the behavioral attributes of the user;
receiving, by the decisioning system and from the client device, a second request indicating one or more alternative data sources that are selected, from the recommended set of alternative data sources, for providing information related to the behavioral attributes of the user;
obtaining, by the decisioning system, the information related to the behavioral attributes of the user from the one or more alternative data sources that are selected by the user; and
generating, by the decisioning system, a decision associated with the application for the user based on the information obtained from the one or more alternative data sources.

11. The method of claim 10, further comprising:
evaluating an effectiveness of the one or more alternative data sources used to generate the decision associated with the application; and
updating the machine learning model based on the effectiveness of the one or more alternative data sources used to generate the decision associated with the application.

12. The method of claim 10, wherein the set of observations related to the effectiveness of the one or more combinations of alternative data sources indicate whether the application decisions were approved or rejected for the users sharing the one or more profile attributes with the user of the client device.

13. The method of claim 10, wherein the machine learning model is used to generate the recommended set of alternative data sources based on a profile associated with the user of the client device.

14. The method of claim 10, further comprising:
communicating with a primary data source that stores historical behavior data for a population of users to request information relevant to the behavioral attributes of the user,
wherein the machine learning model is used to generate the recommended set of alternative data sources based on the historical behavior data stored in the primary data source for the user being insufficient to generate the decision on the application.

15. The method of claim 10, further comprising:
communicating with a primary data source that stores historical behavior data for a population of users to request information relevant to the behavioral attributes of the user,
wherein the machine learning model is used to generate the recommended set of alternative data sources based on the historical behavior data stored in the primary data source indicating that the application should be rejected for the user.

16. A non-transitory computer-readable medium storing a set of instructions, the set of instructions comprising:
one or more instructions that, when executed by one or more processors of a system, cause the system to:
receive a first request to access an application from a client device associated with a user;
use a machine learning model to generate a recommended set of alternative data sources for providing information related to behavioral attributes of the user,
wherein the machine learning model generates the recommended set of alternative data sources based on a set of observations related to an effectiveness of one or more combinations of alternative data sources for generating application decisions for users sharing one or more profile attributes with the user of the client device;
present an interface associated with the application to the client device associated with the user,
wherein the interface indicates that the recommended set of alternative data sources are available for providing information related to the behavioral attributes of the user;
receive, from the client device, a second request indicating one or more alternative data sources that are selected, from the recommended set of alternative data sources, for providing information related to the behavioral attributes of the user;
obtain the information related to the behavioral attributes of the user from the one or more alternative data sources that are selected by the user;
generate a decision associated with the application for the user based on the information obtained from the one or more alternative data sources;
evaluate an effectiveness of the one or more alternative data sources used to generate the decision associated with the application; and
update the machine learning model based on the effectiveness of the one or more alternative data sources used to generate the decision associated with the application.

17. The non-transitory computer-readable medium of claim 16, wherein the set of observations related to the effectiveness of the one or more combinations of alternative data sources indicate whether the application decisions were approved or rejected for the users sharing the one or more profile attributes with the user of the client device.

18. The non-transitory computer-readable medium of claim 16, wherein the machine learning model is used to generate the recommended set of alternative data sources based on a profile associated with the user of the client device.

19. The non-transitory computer-readable medium of claim 16, wherein the one or more instructions further cause the system to:
communicate with a primary data source that stores historical behavior data for a population of users to request information relevant to the behavioral attributes of the user,
wherein the machine learning model is used to generate the recommended set of alternative data sources based on the historical behavior data stored in the primary data source for the user being insufficient to generate the decision on the application.

20. The non-transitory computer-readable medium of claim 16, wherein the one or more instructions further cause the system to:
communicate with a primary data source that stores historical behavior data for a population of users to request information relevant to the behavioral attributes of the user,
wherein the machine learning model is used to generate the recommended set of alternative data sources based on the historical behavior data stored in the primary data source indicating that the application should be rejected for the user.
